(19) United States
(12) Patent Application Publication
(10) Pub. No.: US 2017/0070185 A1
(43) Pub. Date: Mar. 9, 2017

(54) Integrated Solar Energy Window Wall System

(71) Applicant: Advanced Building Systems, Inc., Wilmington, DE (US)

(72) Inventor: Raymond M.L. Ting, Pittsburgh, PA (US)

(21) Appl. No.: 15/232,130

(22) Filed: Aug. 9, 2016

Related U.S. Application Data
(60) Provisional application No. 62/215,383, filed on Sep. 8, 2015.

(51) Int. Cl. H02S 20/26; E06B 5/00; H02G 3/30; H02S 30/10

(52) U.S. Cl. CPC H02S 20/26; H02S 30/10; E06B 5/00; H02G 3/30

(57) ABSTRACT

An airloop window wall system with solar energy units integrated into the window wall panels is disclosed. The disclosed system provides electrical connections between adjacent solar energy window wall panels without compromising the window wall watertightness performance and permits easy replacement of solar energy units from the building interior.

### CROSS-REFERENCE TO RELATED APPLICATIONS

This application claims the benefit under 35 U.S.C. §119(e) of the earlier filing dates of U.S. Provisional Patent Application No. 62/215,383 filed on Sep. 8, 2016.

### BACKGROUND OF THE INVENTION

1. Field of Invention

This invention relates to an exterior panelized window wall system with integrated solar energy units.

2. Background of the Invention

An exterior window wall system is formed by joining panels side-by-side and supporting them with continuous horizontal track members anchored to surfaces above a floor slab (i.e., a sill or base track) and horizontal track members anchored under a floor slab of the floor above (i.e., a ceiling track). Some major functions of an exterior window wall system are to prevent water infiltration, prevent interior water condensation, absorb wind load, and absorb seismic load. In a conventional window wall system, there are many technical problems associated with the above performance functions due to inevitable construction tolerance problems and the requirement of an exterior sealing envelope.

There currently are no commercially available solar energy systems for out-hanging on or integrating in a window wall system. For a solar energy system with solar energy units either out-hanging on or integrated into a window wall, the need for wiring penetrating the exterior sealing envelope presents technical challenges. In addition, a major problem with integrating a solar energy unit into a window wall is the difficulty and expense required to replace a dysfunctional or damaged solar energy unit. An economical solution for an integrated solar energy window wall is highly desirable.

### BRIEF SUMMARY OF THE INVENTION

Some objectives of preferred integrated solar energy window wall systems of the present invention include fulfilling the following functional performances: (1) Integrating any commercially available solar energy unit into a panelized window wall system without affecting other performance functions such as aesthetic features, water-tightness, and structural safety. (2) Permitting easy replacement of an individual solar energy unit from the building interior. (3) Providing inter-floor electrical wiring connections without drilling a hole through the floor slab.

In preferred embodiments of the present invention, a solar energy unit is integrated into an airloop window wall panel by using the solar energy unit as the panel facing element. U.S. Pat. No. 8,001,738, which is incorporated by reference, describes the application of the pressure equalized airloop principle to a window wall system.

In preferred embodiments, multiple window wall panels having integrated solar energy units are used in a window wall. The solar energy units are electrically connected to each other using inter-panel wires that may pass through holes in the head frame members of the window wall panels and/or through air spaces in the panel frames and panel joints. An inter-floor electrical connection may be made with a wiring path over the outside edge of a floor slab.

### BRIEF DESCRIPTION OF THE DRAWINGS

FIG. 1 is a typical partial elevation of an airloop solar energy window wall system of a preferred embodiment.

FIG. 2 is an isometric back view of a shop-assembled and ready to be erected airloop solar energy window wall panel of a preferred embodiment with an insulated glass solar energy unit.

FIG. 3 is an isometric back view of a shop-assembled and ready to be erected airloop solar energy window wall panel of a preferred embodiment with a single glass solar energy unit.

FIG. 4 is a fragmental cross-section taken along line 4-4 of FIG. 1, showing an upper wall panel with an integrated glass solar energy unit, a lower wall panel with an insulated glass solar energy unit, and a concrete floor slab in between, and a preferred wiring path for an inter-floor electrical connection between solar energy units.

FIG. 5 is a fragmental cross-section taken along line 5-5 of FIG. 1, showing the vertical joint between adjacent window wall panels and showing the utilization of a vertical airloop space as a vertical wiring channel.

FIG. 6 is an exploded, isometric back view looking downwardly at the head frame members of two adjacent window wall panels, illustrating a preferred inter-panel wiring path.

### DETAILED DESCRIPTION OF THE INVENTION

Reference will now be made in detail to the preferred embodiments of the present invention, examples of which are illustrated in the accompanying drawings. For the purpose of clarity, in the following descriptions, the required protective sleeves for electrical wiring at the hole locations on the aluminum extrusions are not shown in the drawings.

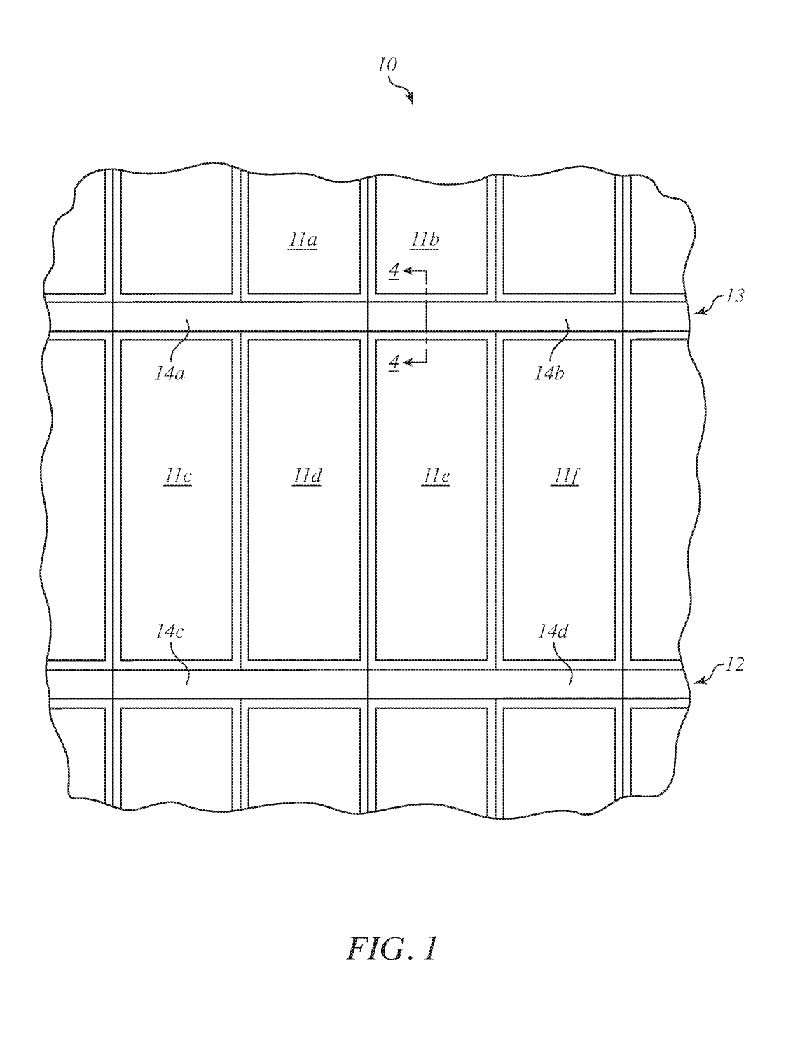

FIG. 1 is a typical partial elevation of an airloop solar energy window wall system 10 of a preferred embodiment with side by side panels 11c, 11d, 11e, 11f spanning between two adjacent floors 12 and 13. Side-by-side panels 11a, 11b span between floor 12 and the floor above. The floor slab edges are aesthetically covered by cover plates 14a, 14b, 14c, 14d.

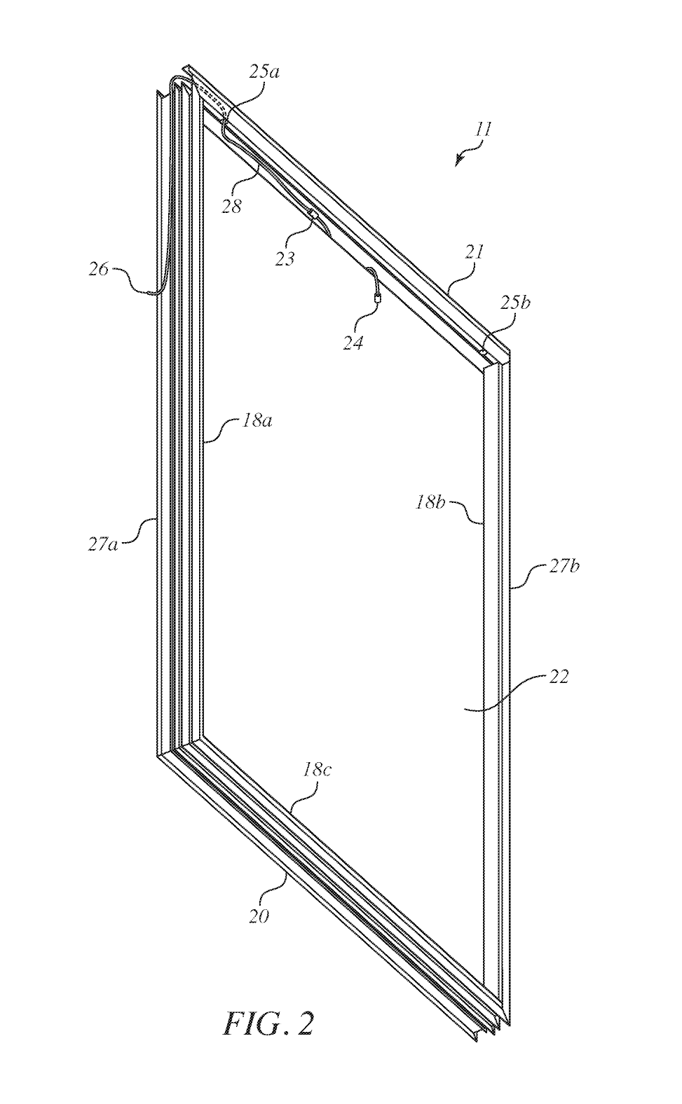

FIG. 2 is an isometric back view (looking upwardly on the underside of the head frame member 21) of a shop-assembled and ready to be erected airloop solar energy window wall panel 11 of a preferred embodiment having an insulated glass solar energy unit 22.

The insulated glass solar energy unit 22 may be any commercially-available insulated glass solar energy unit and has an interior glass pane and an exterior glass pane. A wire chase is sandwiched between the glass panes and has a positive outlet wire with a shop-installed positive connector 23 and a negative outlet wire with a shop-installed negative connector 24.

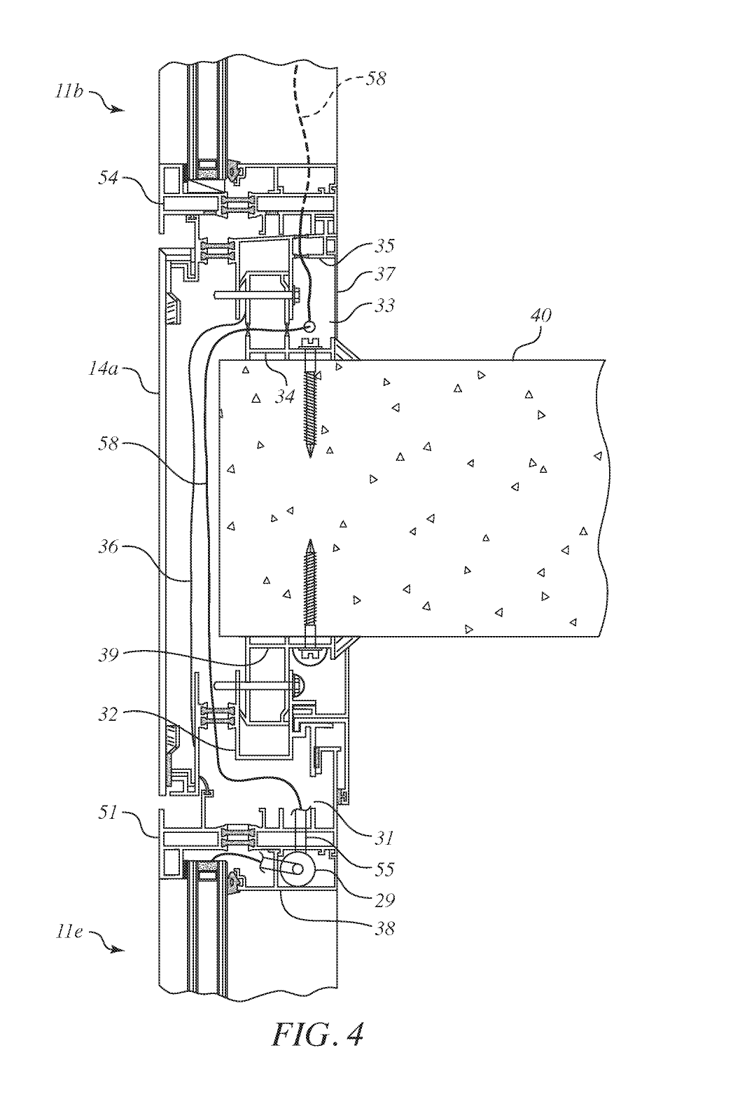

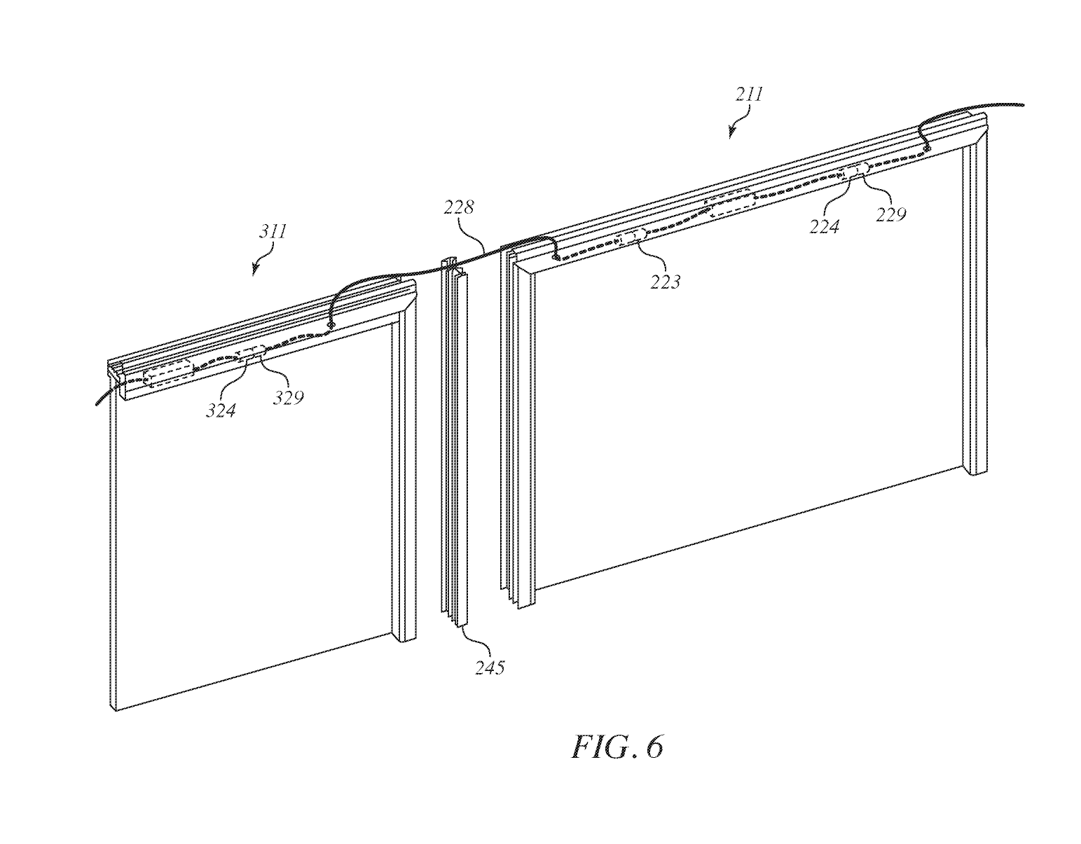

The insulated glass solar energy unit 22 is secured in an airloop panel perimeter frame. The shop-assembled airloop panel perimeter frame has a head frame member 21, two jamb frame members 27a, 27b, and a sill frame member 20. The solar energy unit 22 is structurally secured inside the panel frame on three sides (sill and two side jambs) by demountable glazing beads 18a, 18b, 18c. A glazing bead for the head frame member is added during panel erection, as described below in the description accompanying FIGS. 4 and 6. Two wiring holes 25a, 25b are provided on the head frame member 21.

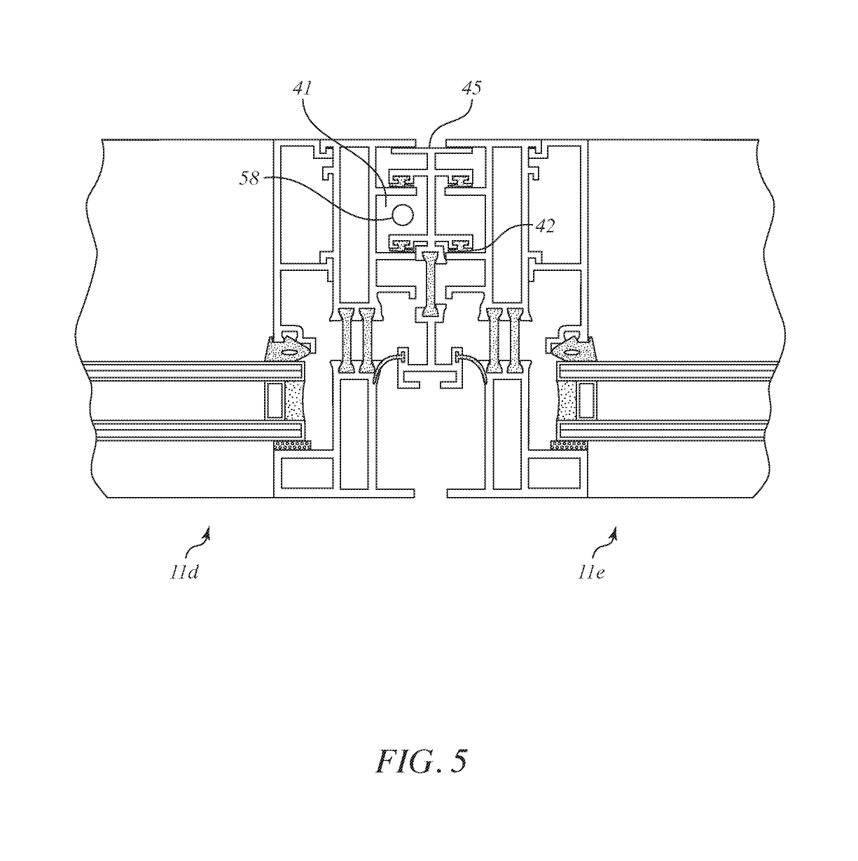

As one of ordinary skill in the art would recognize as described in U.S. Pat. No. 8,001,738, an assembled airloop panel has air spaces substantially forming a loop around and near the panel facing element (e.g., a solar energy unit) and generally within the panel perimeter frame. The airloops are connected to exterior air to provide pressure equalization that prevents water infiltration. Additional pressure-equalized spaces are formed in the joints between adjacent panels, as shown in FIG. 5.

In a preferred embodiment, one of the electrical connectors 23 of the solar energy unit 22 is shop-connected to an inter-panel wire 28. The inter-panel wire 28 is threaded through a wiring hole 25a to the exterior side of the head frame member 21. The loose end 26 of the inter-panel wire 28 hangs outside of the jamb frame member 27 for connection to a solar energy unit in a different wall panel (e.g., a wall panel next to, above, or below the wall panel 11) upon installation. The wiring hole 25b on the other side of the head frame member 21 is provided for guiding the inter-panel wire of an adjacent panel to make a field connection to the electrical connector 24. The length of the inter-panel wire depends on the distance required to make the inter-panel connection.

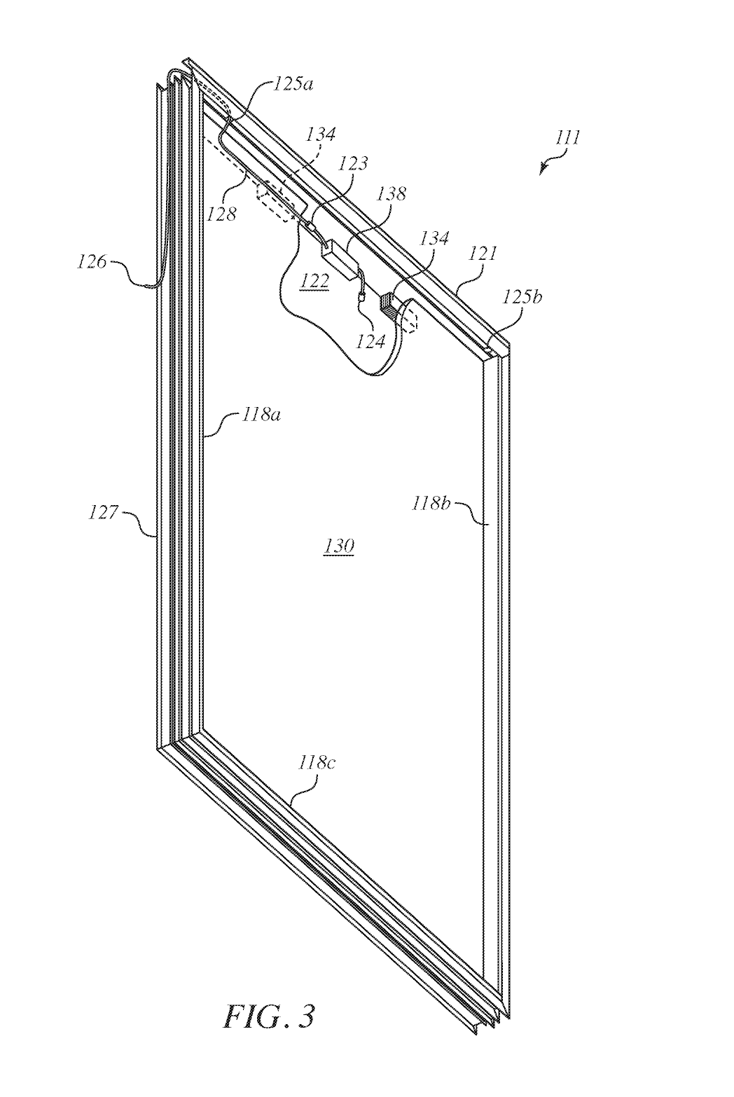

FIG. 3 shows an isometric back view of a shop-assembled and ready to be erected airloop solar energy window wall panel 111 of a preferred embodiment having a single glass solar energy unit 122 with a structural back-up panel 130. For illustration purposes, a portion of the structural panel 130 is cut away in FIG. 3 to show a portion of the solar energy unit 122. The single glass solar energy unit 122 may be a commercially-available single glass solar energy unit. The single glass solar energy unit 122 has a wire chase 138, a positive outlet wire with a shop-installed positive connector 123 and a negative outlet wire with a shop-installed negative connector 124. The electrical connectors 123, 124 may be made as integral parts of the wire chase 138, eliminating the outlet wires.

For adaptation of the single glass solar energy unit 122 into the present invention, spaced apart structural spacer blocks 134 having the same depth of the wire chase 138 are included around the perimeter of the glass pane of the single glass solar energy unit. The structural spacer blocks 134 may be shop-glued to glass pane. The required number of spacer blocks 134 depends on the size of the glass pane. For purposes of clarity, only two spacer blocks 134 are shown in FIG. 3. The structural panel 130 is placed behind the solar energy unit 122, against the spacer blocks 134 and wire chase 138. The solar energy unit 122 and the structural panel 130 are structurally secured inside the panel frame on three sides (sill and two side jambs) by demountable glazing beads 118a, 118b, 118c.

As with the embodiment shown in FIG. 2, one of the electrical connectors 123 of the solar energy unit 122 is shop connected to an inter-panel wire 128, which is threaded through a wiring hole 125a to the exterior side of the head frame member 121. The loose end 126 of the inter-panel wire 128 hangs outside of the jamb frame member 127 for connection to a solar energy unit in a different wall panel (e.g., a wall panel next to, above, or below the wall panel 111) upon installation. A wiring hole 125b is provided on the other side of the head frame member for guiding the inter-panel wire of an adjacent panel to make a field connection to the electrical connector 124. The length of the inter-panel wire depends on the distance required to make the inter-panel or inter-floor connection.

FIG. 4 shows a fragmental cross-section taken along line 4-4 of FIG. 1, showing an upper wall panel 11b, a lower wall panel 11e, with a concrete floor slab 40 in between. In this preferred embodiment, each of the upper wall panel 11b and the lower wall panel 11e has an integrated, insulated glass solar energy unit. The sill frame member 54 of the upper wall panel 11b is engaged with a base positioning track 35, which is secured to the top of the concrete floor slab 40 via a base anchoring track 34. The head frame member 51 of the lower wall panel 11e is engaged with a ceiling positioning track 32, which is secured to the underside of the concrete floor slab 40 via a ceiling anchoring track 39.

Based on the airloop window wall system technology described in U.S. Pat. No. 8,001,738, the space 31 between the ceiling positioning track 32 and the head frame member 51 is the top leg of an outer airloop. This space 31 may be used as a horizontal wiring channel for wire connecting solar energy units of adjacent wall panels (see FIG. 6 for details). The space 33 between the base anchoring track 34 and the base positioning track 35 also may be used as a horizontal wiring channel.

FIG. 4 also shows a preferred wiring path for an inter-floor electrical connection between the solar energy units of wall panels 11b, 11e. For inter-floor wire connections, a preferred wiring procedure for connecting the solar energy unit in wall panel 11b to the solar energy unit in wall panel 11e includes the following steps: (1) At a selected location, guide an inter floor wire 58 through the dry vertical segment 41 (shown in FIG. 5) of the outer airloop and penetrate through the base positioning track 35 into the interior wiring channel 33; (2) Guide the wire 58 horizontally inside the wiring channel 33 to a selected location and penetrate through the base anchoring track 34 to go outside of the floor slab edge; (3) Guide the wire 58 down over the floor slab edge and penetrate through the ceiling positioning track 32 of the panel below to reach the wiring channel 31; (4) Guide the wire 58 horizontally in the wiring channel 31 to a selected location and guide the wire 58 through a wiring hole 55 provided in the head frame member 51 into the interior side of panel 11e; (5) Field-install the connector 29 and connect it to the connector of the solar energy unit in panel 11e; (6) From the building exterior, roll down the slab edge membrane 36 and install the slab edge cover 14a; (7) From the building interior, snap on the interior base cover 37 and install the head glazing bead 38.

The above wiring procedures may be easily completed in open spaces before steps (6) and (7). Even though the wiring penetrations in steps (1) and (2) are between the pressure equalized airloop space (41 or 31) and the interior air space 33, they are within the dry segment of the outer airloop; therefore, the wiring penetrations will not cause water leakage. The wiring penetrations in steps (3) and (4) are between pressure-equalized airloop spaces; therefore, they will not cause water leakage.

FIG. 5 shows a fragmental cross-section taken along line 5-5 of FIG. 1, showing the vertical joint between adjacent window wall panels 11d, 11e. The vertical joint between side-by-side window wall panels 11d, 11e is formed with a vertical joint member 45 in between and engaged with wall panel 11d and wall panel 11e. The vertical joint is formed during installation of the wall panels 11d, 11e and vertical joint member 45 in the manner described in U.S. Pat. No. 8,001,738.

To summarize a preferred installation procedure, after installation of base and ceiling positioning tracks and anchoring tracks (as shown in FIG. 4), a window wall panel is erected from the building interior by engagement of the sill frame member with the base positioning track and engagement with the head frame member with the ceiling positioning track. To install an adjacent window wall panel, a vertical joint member is engaged with the jamb frame member of the already-erected window wall panel. Next, the top of the panel to be erected from the building interior is tilted inwardly and slightly away from the vertical joint member. The panel to be erected is then dropped into bottom engagement with the base positioning track. Due to the dead weight moment, the top of the panel will swing outwardly and cause contact with the ceiling track. The panel can then be slid laterally to cause panel jamb engagement with the vertical joint member. Panel jamb engagement with the vertical joint member forms vertical airloop spaces (such as the vertical airloop space 41 shown in FIG. 5) between the panel jamb frame member and the vertical joint member.

FIG. 5 shows the utilization of the vertical airloop space 41 as a vertical wiring channel for an inter-floor wire 58 to provide an electrical connection between solar energy units in wall panels on different floors. The vertical airloop space is formed between the jamb frame member of the panel 11d and the vertical joint member 45 when the jamb frame member is engaged with the vertical joint member during panel erection. The wiring channel 41 is behind the water seal line 42; therefore, the wiring path is within the dry segment of the outer airloop (see U.S. Pat. No. 8,001,738). During panel erection as described above, the wiring of the vertical segment of wire 58 may be performed with open channel access using either of the following two options: (1) Erecting right panel 11e, engaging vertical joint member 45 with the erected panel 11e, inserting wire 58 in space 41, then engaging of the left panel 11d to vertical joint member 45; or (2) erecting left panel 11d, inserting wire 58 in space 41, engaging vertical joint member 45 to left panel 11d, and engaging right panel 11e to vertical joint member 45.

FIG. 6 shows an exploded, isometric back view looking downwardly at the head frame members of two adjacent panels 211 and 311 to illustrate a preferred procedure for making an inter-panel wiring connection between side-by-side panels during panel erection. In order to show the wiring path and connection procedures clearly, the panels 211, 311 and the vertical joint member 245 are shown in an exploded view before the erection engagement. Right panel 211 is erected first with loose inter-panel wire 228 shop connected to the electrical connector 223 (as shown in FIG. 2 or FIG. 3). Left panel 311 is the next panel to be erected with an unconnected electrical connector 324 (as shown in FIG. 2 or FIG. 3). The preferred panel erection and inter-panel wiring procedures for left panel 311 are explained as follows from the building interior: (1) Engage the bottom of the left panel 311 to the base positioning track (shown in FIG. 4) at a location laterally away from the erected right panel 211 and tilt the top of panel 311 slightly inwardly to expose the wire hole 311 (as shown in FIG. 2 or 3) in the head frame member of panel 311. (2) Guide the loose end of the inter-panel wire 228 from the right panel 211 through the wire hole in the head frame of the left panel 311 into the interior side of the left panel 311. (3) Engage the vertical joint member 245 into position with the jamb frame member of the erected right panel 211. (4) Slide the left panel laterally towards the vertical joint member 245 and the right panel 211 and engage the jamb frame member of the left panel 311 with the vertical joint member 245. (5) Cut off any excess length of the inter-panel wire 228 and field-install the wire connector 329. (6) Connect the wire connector 329 of the inter-panel wire 228 to the wire connector 324 of the solar energy unit in the left panel 311 to complete the electrical connection between the solar energy unit in the right panel 211 and the solar energy unit in the left panel 311. (7) Install head glazing beads to the head frame members of the panels 211, 311 to complete the air seal around the panel perimeter frames and to conceal the wiring systems in panels 211, 311. The head glazing beads preferably have notches at the locations of wires and wire connectors to allow wires to pass through and/or to accommodate space taken up by wire connectors. Steps 5, 6, and 7 may be executed separately during the wall erection or after the completion of the wall erection. When the wall panels 211, 311 are erected, the horizontal path of the inter-panel wire 228 is through the outer airloop spaces (corresponding to airloop space 31 in FIG. 4) formed between the ceiling positioning track and each of the head frame members of the panels 211, 311.

Solar energy units may be replaced if damaged or dysfunctional, to upgrade to new solar energy technology, or for any other reason replacement is desired. Preferred embodiments of the present invention allow for easy replacement of solar energy units from the interior side of the building. With reference to the preferred embodiment wall panel 11 of FIG. 2, replacement of an insulated glass solar energy unit 22 may be accomplished by the following preferred steps: (1) Deglaze the panel 11 by removing the glazing beads on all four sides of the solar energy unit 22. (2) Disconnect both connectors of the solar energy unit 22 from the respective inter-panel wire connectors and remove solar energy unit 22 from the panel frame. (3) Place a new solar energy unit into the panel frame and re-connect the wire connectors (no need to field-install the connectors on the inter-panel wires because they are already in place). (4) Reinstall the glazing beads on all four sides of the new solar energy unit to secure the new solar energy unit to the panel frame.

With reference to the preferred embodiment wall panel 111 of FIG. 3, the preferred procedure for replacing a single glass solar energy unit 122 are similar to the above steps, except the above steps (2) and (3) involve additional removal and replacement of the structural panel 130, which may be reused.

Even though a typical airloop window wall unit is used in illustrating the present invention, some of the design features can be used in other conventional systems to improve their functional performance.

Nothing in the above description is meant to limit the present invention to any specific materials, geometry, or orientation of elements. Many modifications are contemplated within the scope of the present invention and will be apparent to those skilled in the art. The embodiments described herein were presented by way of example only and should not be used to limit the scope of the invention.

For example, different panel systems and solar energy units may be used with the present invention. Use of different panel systems or solar energy units may require dimensional changes for panel glazing beads. The same panel joint design can be used for different panel systems. Therefore, different panel systems can be easily erected side-by-side in any combination.

1. An integrated solar energy window wall system comprising:
a first airloop window wall panel comprising a first solar energy unit secured in a first perimeter frame,
a second airloop window wall panel comprising a second solar energy unit secured in a second perimeter frame,
a ceiling positioning track engaged with said first perimeter frame and engaged with said second perimeter frame, forming a first outer airloop space between said first perimeter frame and said ceiling positioning track and forming a second outer airloop space between said second perimeter frame and said ceiling positioning track, and
an inter-panel wire in said first outer airloop space and in said second outer airloop space, wherein said inter-panel wire provides an electrical connection between said first solar energy unit and second solar energy unit.

2. The integrated solar energy window wall system of claim 1, wherein said first solar energy unit can be removed from said first perimeter frame from a building interior.

3. The integrated solar energy window wall system of claim 1, wherein said first solar energy unit is an insulated glass solar energy unit.

4. The integrated solar energy window wall system of claim 1, wherein said first solar energy unit is a single glass solar energy unit.

5. An integrated solar energy window wall system comprising:
a first airloop window wall panel comprising a first solar energy unit secured in a first perimeter frame,
a base positioning track engaged with said first perimeter frame,
a base anchoring track connected to said base positioning track and secured to the top of a floor slab,
a ceiling anchoring track secured to the underside of said floor slab,
a ceiling positioning track connected to said ceiling anchoring track,
a second airloop window wall panel comprising a second solar energy unit secured in a second perimeter frame, wherein said second perimeter frame is engaged with said ceiling positioning track,
an inter-panel wire providing an electrical connection between said first solar energy unit and said second solar energy unit, wherein said inter-panel wire is disposed over an outside edge of said floor slab.

6. The integrated solar energy window wall system of claim 5, wherein said first solar energy unit can be removed from said first perimeter frame from a building interior.

7. The integrated solar energy window wall system of claim 5, wherein said first solar energy unit is an insulated glass solar energy unit.

8. The integrated solar energy window wall system of claim 5, wherein said first solar energy unit is a single glass solar energy unit.

9. The integrated solar energy window wall system of claim 5, further comprising a vertical joint member engaged with said first perimeter frame, wherein said inter-panel wire is disposed in a vertical wiring channel formed between said first perimeter frame and said vertical joint member.
